(19) United States
(12) Patent Application Publication
(10) Pub. No.: US 2025/0355476 A1
(43) Pub. Date: Nov. 20, 2025

(54) Computer peripheral device control system

(71) Applicant: Chien-Hao CHEN, Keelung City (TW)

(72) Inventor: Chien-Hao CHEN, Keelung City (TW)

(21) Appl. No.: 18/784,027

(22) Filed: Jul. 25, 2024

(30) Foreign Application Priority Data
May 14, 2024 (TW) 113117773

(51) Int. Cl. G06F 1/20; G06F 1/26

(52) U.S. Cl. CPC G06F 1/206; G06F 1/26

(57) ABSTRACT

A peripheral device control system for a computer is disclosed. The peripheral device control system may include a computer motherboard, a plurality of light-emitting peripheral devices and a signal transceiver device. One or more of the light-emitting peripheral devices may be electrically connected to a corresponding connecting device. Each connecting device may be provided with a signal receiving unit and a power cord. The signal transceiver device may include a signal receiver module and a signal transmitter module. The signal receiver module may be remotely connected to a control interface for receiving at least one command signal. The signal transmitter module may be remotely connected to the signal receiving unit of each connecting device such that command signal(s) sent to the signal receiving unit of at least one connecting device change the operating mode of a corresponding light-emitting peripheral device.

### FIELD OF THE DISCLOSURE

The present disclosure is related to a peripheral device control system with a simple structure, low cost and quick assembly, and which is particularly suitable for use with computers having multiple sets of light-emitting fans and/or multiple light-emitting cable connected internally.

### BACKGROUND OF THE DISCLOSURE

In recent years, the development of computer devices is rapid. As time evolves, the application of computing devices can be seen everywhere. Computers have a variety of execution and calculation functions that can meet people's needs. Personal computers have functions such as entertainment, word processing, and image playback in family life. Industrial computers provide control, supervision, and computing services for factory operations. Vehicle computers provide drivers and passengers with multimedia entertainment and the ability to receive information in real time. Overall, computers have become an indispensable device in human social life.

In today's era of rising consumer awareness and fierce competition in electronic products, in order to win the favor and attention of more consumers, appearance or shape can be important.

### SUMMARY OF THE DISCLOSURE

The present disclosure describes a peripheral device control system with a simple structure, low cost, and quick assembly. The control system is particularly suitable for use of desktop computers with multiple sets of light-emitting fans and/or multiple light-emitting cables internally and/or externally connected.

In one embodiment, the present disclosure provides a peripheral device control system, which comprises a computer motherboard, a plurality of light-emitting peripheral devices and a signal transceiver device. At least one of the plurality of light-emitting peripheral devices, and sometimes all of the plurality of light-emitting devices, is electrically connected to a corresponding one of a plurality of connecting devices. In one embodiment, at least one of the plurality of connecting devices on a corresponding one of the plurality of light-emitting peripheral devices can control an operating mode of the corresponding one of the plurality of light-emitting peripheral devices. In one embodiment, all of the plurality of connecting devices on a corresponding one of the plurality of light-emitting peripheral devices can control an operating mode of the corresponding one of the plurality of light-emitting peripheral devices. In one embodiment, at least one of the plurality of connecting devices is provided with a signal receiving unit and a power cord. In one embodiment, the signal transceiver device is used for connecting to the computer motherboard. In one embodiment, the signal transceiver device has a signal receiver module and a signal transmitter module. In one embodiment, the signal receiver module is remotely connected to a control interface for receiving at least one command signal generated by the control interface. In one embodiment, the signal transmitter module is remotely connected to the signal receiving unit of each of the plurality of connecting devices respectively. In one embodiment, when the command signal is respectively sent to the signal receiving unit of at least one of the plurality of connecting devices through the signal transmitter module, at least one of the plurality of connecting devices is respectively driven to change the operating mode of at least one of the plurality of light-emitting peripheral devices corresponding to the at least one of the plurality of connecting devices respectively. In one embodiment, the operating mode includes one of an emitting-light mode and a rotating speed mode.

In one embodiment, the computer motherboard is connected to a power supply for receiving electrical energy provided by the power supply.

In one embodiment, the power cord at one end of at least one of the plurality of connecting devices is electrically connected to the computer motherboard and the other end of the at least one of the plurality of connecting devices is detachably jointed to a corresponding one of the plurality of light-emitting peripheral devices for obtaining electrical energy from the computer motherboard.

In one embodiment, the power cord at one end of at least one of the plurality of connecting devices is electrically connected to the power supply and the other end of the at least one of the plurality of connecting devices is detachably jointed to a corresponding one of the plurality of light-emitting peripheral devices for obtaining electrical energy from the power supply.

In one embodiment, the plurality of light-emitting peripheral devices includes at least one of: a light-emitting fan, a light-emitting cable or both a light-emitting fan and a light-emitting cable.

In one embodiment, the control interface is capable of generating a plurality of command signals with different commands, with at least some of the plurality of command signals corresponding to a signal receiving unit of each of the plurality of connecting devices. In one embodiment, at least some of the plurality of command signals are sent through a signal transmitter module. In one embodiment, at least one of the plurality of light-emitting peripheral devices is driven to operate in different operating modes corresponding to different command signals received from the control interface.

In one embodiment, the control interface includes a software program, the control interface generates the plurality of command signals corresponding to an input-command when a user inputs the input-command into the control interface according to the user's usage requirements.

For further understanding the characteristics and effects of the present disclosure, some embodiments referred to drawings are in detail described as follows.

### BRIEF DESCRIPTION OF DRAWINGS

FIG. 1 is a schematic diagram of an embodiment of the present disclosure.

FIG. 2 is a schematic system architecture diagram of an embodiment of the present disclosure.

### DETAILED DESCRIPTIONS OF PREFERRED EMBODIMENTS

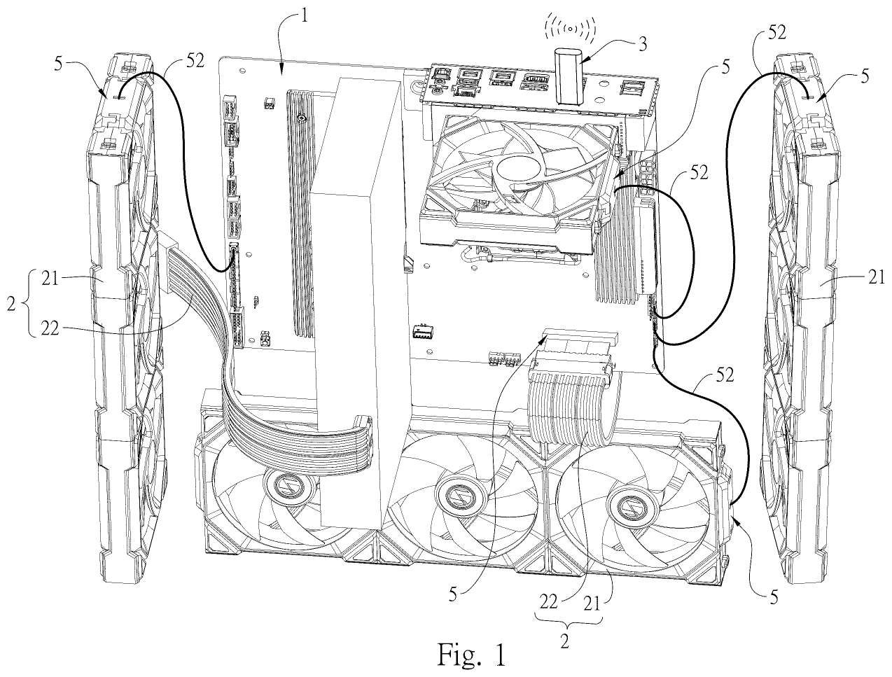

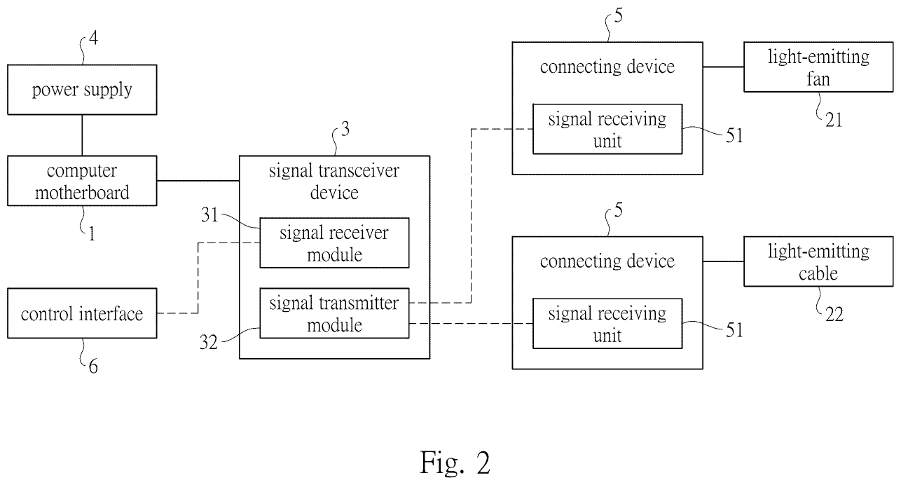

Reference is now made to FIGS. 1 and 2, which illustrate one non-limiting embodiment of a peripheral device control system in accordance with the present disclosure.

In the illustrated embodiment, a peripheral device control system includes a computer motherboard 1, a plurality of light-emitting peripheral devices 2 and a signal transceiver device 3.

In the illustrated embodiment, the computer motherboard 1 is connected to a power supply 4 for receiving electrical energy provided by the power supply 4.

In the illustrated embodiment, the light-emitting peripheral device 2 includes both a light-emitting fan 21 and a light-emitting cable 22, although the light-emitting peripheral device could include either a light-emitting fan 21 or a light-emitting cable 22. In the illustrated embodiment, each light-emitting peripheral device 2 is electrically connected to a connecting device 5. Each connecting device 5 on a corresponding light-emitting peripheral device 2 can control an operating mode of the corresponding light-emitting peripheral device 2. Each connecting device 5 is provided with a signal receiving unit 51 and a power cord 52.

In the illustrated embodiment, the signal transceiver device 3 is in electrical communication with the computer motherboard 1 (e.g., via a suitable port on the motherboard 1). In the illustrated embodiment, the signal transceiver device 3 includes a signal receiver module 31 and a signal transmitter module 32. The signal receiver module 31 may be connected (e.g., remotely connected) to a control interface 6 for receiving at least one command signal generated by the control interface 6. In the illustrated embodiment, the signal transmitter module 32 is remotely connected to the signal receiving unit 51 of each connecting device 5 respectively.

The control interface 6 may include a software program. The control interface 6 may generate at least some of, or all of, the plurality of command signals corresponding to an input-command when a user inputs the input-command into the control interface 6 according to the user's usage requirements. In one embodiment, when a command signal 6 is respectively sent to the signal receiving unit 51 of at least one connecting device 5 (e.g., through the signal transmitter module 32), the at least one connecting device 5 may be respectively driven to change the operating mode of at least one light-emitting peripheral device 2 corresponding to the at least one connecting device 5.

In one embodiment, the control interface 6 is capable of generating command signals with a plurality of different commands. Each of the command signals may be sent to the signal receiving unit 51 of a corresponding connecting device 5 (e.g., through the signal transmitter module 32). When a connecting device 5 receives different command signals with different commands, a corresponding light-emitting peripheral device 2 is driven to operate in different operating modes corresponding to the different commands. For instance, upon receiving a first command signal, a corresponding light-emitting peripheral device 2 may be driven to operate in a first operating mode. Upon receiving a second command signal, a corresponding light-emitting peripheral device 2 may be driven to operate in a second operating mode, different than the first operating mode. Any number of command signals may be used. In one embodiment, the operating mode is an emitting-light mode. In another embodiment, the operating mode is a rotating speed mode. In another embodiment, the operating mode relates to both the emitting-light mode and the rotating speed mode. For example, when the light-emitting peripheral device 2 is a light-emitting fan 21, the operating mode of the light-emitting fan 21 includes an emitting-light mode and a rotating speed mode for controlling the rotation of fan blades of the light-emitting fan 21. As another example, when the light-emitting peripheral device 2 is a light-emitting cable 22, the operating mode of the light-emitting cable 22 includes only an emitting-light mode.

In one embodiment, one end of a connecting device 5 is detachably jointed to a corresponding light-emitting peripheral device 2. In one embodiment, a power cord 52 at the other end of each connecting device 5 is used as a power supply connection terminal. The power cord 52 can be electrically connected to the computer motherboard 1 or the power supply 4, depending on actual power usage requirements, so that the corresponding light-emitting peripheral device 2 can obtain electrical energy from the computer motherboard 1 or the power supply 4.

In one embodiment, a light-emitting peripheral device 2 includes a plurality of the light-emitting fans 21 and the light-emitting cable 22 wherein each light-emitting fan 21 is detachably jointed to one end of a corresponding connecting device 5 while the other end of the corresponding connecting device 5 is connected to the computer motherboard 1 (e.g., through the power cord 52), such that the light-emitting fan 21 can obtain electrical energy from the computer motherboard 1. In another embodiment, a light-emitting cable 22 is detachably jointed to one end of a corresponding connecting device 5 while the other end of the corresponding connecting device 5 is connected to the power supply 4, such that the light-emitting cable 22 can obtain electrical energy from the power supply 4. Therefore, when a user is able, via the control interface 6, to selectively change the color and/or rotation direction and/or rotation speed of a plurality of light-emitting fans 21. For instance, a user may drive all the light-emitting fans 21 to synchronize or individually change the color of the light of each of the light-emitting fans 21, and the user can issue a command through the control interface 6. In response thereto, a corresponding command signal or a plurality of corresponding command signals may be generated by the control interface 6 and sent to the signal receiver module 31 of the signal transceiver device 3. The corresponding command signal or the plurality of corresponding command signals may be then respectively sent to the signal receiving unit 51 of each connecting device 5 through the signal transmitter module 32 of the signal transceiver device 3 such that the selected light-emitting peripheral devices 2, corresponding to the connecting devices 5, are respectively driven to change the selected operating mode (e.g., the same luminous colors or different luminous colors).

As may be appreciated, based on the foregoing, the present disclosure effectively provides for a system that integrates and controls all the light-emitting peripheral devices by utilizing a signal transceiver device to uniformly receive command signals and transmit each of the command signals. The user only need to operate the control interface to easily, quickly and selectively adjust the operating mode of each light-emitting peripheral device to achieve the visual experience the user desires.

In one embodiment, some or all the light-emitting peripheral devices are driven/controlled through wireless transmission control, although wired control could also be used. In one embodiment, only one power cord is needed for each light-emitting peripheral device, such as a light-emitting fan or a light-emitting cable, which can effectively reduce the amount of wiring inside and/or outside the computer, making the inside and/or outside of the computer neat (e.g., visually attractive), and more convenient for user to perform installation or replacement operations.

What is claimed is:

1. A peripheral device control system comprising:
a computer motherboard;
a plurality of light-emitting peripheral devices;
a plurality of connecting devices in electrical communication with the a corresponding one of the plurality of light-emitting devices;
wherein each of the plurality of connecting devices on a corresponding one of the plurality of light-emitting peripheral devices is operable to control an operating mode of the corresponding one of the plurality of light-emitting peripheral devices; and
a signal transceiver device in communication with the computer motherboard, wherein:
the signal transceiver device comprises a signal receiver module and a signal transmitter module;
the signal receiver module is remotely connected to a control interface for receiving at least one command signal generated by the control interface;
the signal transmitter module is remotely connected to the signal receiving unit of each of the plurality of connecting devices such that, when the at least one command signal is respectively sent to the signal receiving unit of at least one of the plurality of connecting devices through the signal transmitter module, the at least one of the plurality of connecting devices is respectively driven to change the operating mode of the light-emitting peripheral device corresponding to the at least one of the plurality of connecting devices.

2. The peripheral device control system according to claim 1, wherein the computer motherboard is connected to a power supply for receiving electrical energy provided by the power supply.

3. The peripheral device control system according to claim 2, wherein each of the plurality of connecting devices is provided with a signal receiving unit and a power cord, and wherein the power cord at one end of each of the plurality of connecting devices is electrically connected to the computer motherboard, and wherein the other end of each of the plurality of connecting devices is detachably jointed to the corresponding light-emitting peripheral device such that the light-emitting peripheral device obtains electrical energy from the computer motherboard.

4. The peripheral device control system according to claim 3, wherein the plurality of light-emitting peripheral devices includes a light-emitting fan, a light-emitting cable, or both thereof.

5. The peripheral device control system according to claim 2, wherein each of the plurality of connecting devices is provided with a signal receiving unit and a power cord, and wherein the power cord at one end of each of the plurality of connecting devices is electrically connected to the power supply, and the other end of each of the plurality of connecting devices is detachably jointed to the corresponding light-emitting peripheral device, so that the light-emitting peripheral device obtains electrical energy from the power supply.

6. The peripheral device control system according to claim 5, wherein the plurality of light-emitting peripheral devices includes a light-emitting fan, a light-emitting cable, or both thereof.

7. The peripheral device control system according to claim 1, wherein the control interface is operable to generate a plurality of command signals with different commands, wherein each of the plurality of command signals is sent to a corresponding one of the signal receiving unit of each of the plurality of connecting devices through the signal transmitter module respectively such that, when one of the plurality of connecting devices receives different command signals with different commands, a corresponding one of the plurality of light-emitting peripheral devices is driven to operate in different operating modes corresponding to the different commands.

8. The peripheral device control system according to claim 7, wherein the operating mode includes at least one of an emitting-light mode and a rotating speed mode.

9. The peripheral device control system according to claim 7, wherein the control interface is operable to generate the plurality of command signals corresponding to an input-command when a user inputs the input-command into the control interface.

10. The peripheral device control system according to claim 1, wherein the operating mode includes at least one of an emitting-light mode and a rotating speed mode.

11. The peripheral device control system according to claim 1, wherein the control interface is operable to generate the plurality of command signals corresponding to an input-command when a user inputs the input-command into the control interface.
